(19) United States
(12) Patent Application Publication
(10) Pub. No.: US 2022/0343436 A1
(43) Pub. Date: Oct. 27, 2022

(54) SYSTEMS, METHODS, AND APPLICATIONS FOR DIVORCE SUPPORT MANAGEMENT

(71) Applicant: Quilt of Ashes, LLC, Atlanta, GA (US)

(72) Inventor: Mandy Mobley Li, Atlanta, GA (US)

(21) Appl. No.: 17/856,702

(22) Filed: Jul. 1, 2022

Related U.S. Application Data
(63) Continuation of application No. 15/983,771, filed on May 18, 2018, now abandoned.
(60) Provisional application No. 62/528,812, filed on Jul. 5, 2017.
(60) Provisional application No. 62/508,967, filed on May 19, 2017.

(51) Int. Cl. G06Q 40/00; G06Q 10/02; G06Q 10/10; G06F 16/93; G06Q 50/18

(52) U.S. Cl. CPC G06Q 40/12; G06Q 10/02; G06Q 10/1093; G06F 16/93; G06Q 50/18; G06Q 50/182

(57) ABSTRACT

A real-time divorce management system including a processing arrangement having a processor and a non-transitory computer-readable medium having instructions stored thereon, the processing arrangement having a processor configured to execute the instructions, upon execution of the instructions, the processor is configured to perform the steps of identifying at least one communication to be analyzed, storing the at least one communication on a memory, identifying, by the processor, predefined characteristics contained in the at least one communication, constructing at least one filtered communication, the filtered communication including a modified version of the at least one communication, and storing the at least one filtered communication into the memory.

### CROSS-REFERENCE TO PRIOR APPLICATIONS

This is a continuation application of U.S. patent application Ser. No. 15/983,771, filed on May 18, 2018, which claims priority to U.S. Provisional Application Ser. No. 62/508,967, filed on May 19, 2017, and U.S. Provisional Application Ser. No. 62/528,812, filed on Jul. 5, 2017. These applications are hereby incorporated by reference herein in their entireties.

### FIELD

Embodiments of the present invention relate to systems, methods, and applications for managing and providing support and services to clients desiring specialized services, such as divorcees.

### BACKGROUND

Relationships can often become strained and toxic to the point where the relationship can break down. The break down and failure of such relationships can be rather emotional. The emotionality associated with the collapse of such a relationship can be exacerbated based on the closeness and intimacy of the involved parties. The increased emotions can lead to difficulties for the involved parties after such a relationship has ended, especially if the parties are forced to maintain some level of contact. One such relationship prone to heightened emotions, which can lead to complications when such a relationship fails, is between married spouses. The difficulties can be further amplified if children are involved. For example, the former spouses may be required to maintain a certain level of contact and communication depending on financial and custody arrangements. Alternatively, or in addition, one or both former spouses may be abusive, vindictive, hiding assets, not fulfilling child support, etc. In such situations, one or both former spouses may be in need of specialized services and support to assist them through the difficult situations. For example, the former spouse(s) may have difficulties in interacting with the other former spouse and may desire certain assistance in their dealings. Additionally, the former spouses may require other forms of assistance during the difficult time.

### SUMMARY

Exemplary embodiments of the present invention can provide a real-time divorce management system including a processing arrangement having a processor and a non-transitory computer-readable medium having instructions stored thereon, the processing arrangement having a processor configured to execute the instructions, upon execution of the instructions, the processor is configured to perform the steps of identifying at least one communication to be analyzed, storing the at least one communication on a memory, identifying, by the processor, predefined characteristics contained in the at least one communication, constructing at least one filtered communication, the filtered communication including a modified version of the at least one communication and storing the at least one filtered communication into the memory.

According to certain embodiments, the modified version of the at least one communication may include modification to the predefined characteristics of the at least one communication. The at least one communication may be one of an outgoing communication or an incoming communication. Further, the at least one communication may include one of a text message, a picture message, an electronic mail, phone calls, VoIP, Wi-Fi calls, or a voicemail

According to certain embodiments, predefined characteristics may include words or images that include at least one of profanity, nudity, violent content, disturbing content, threatening content, graphically violent or sexual content, or emotionally disturbing content.

Another embodiment of the present invention can provide a real-time divorce management system including a processing arrangement having a processor and a non-transitory computer-readable medium having instructions stored thereon, the processing arrangement having a processor configured to execute the instructions, upon execution of the instructions, the processor is configured to perform the steps of providing, to a client device, at least one status for verification, receiving, from the client device, information associated with the at least one status, comparing the verification to predefined criteria to determine a verification state of the at least one status, and transmitting the verification state to the client device.

According to certain embodiments, the processor may be further configured to transmit the verification state to a second client. Further, the processor may be configured to transmit, via a network, reservation information to the selected one authorized transportation vendor.

According to certain embodiments, the at least one status may include one of identification, sobriety, location, time, and safety. Further, the predefined criteria may include at least one of an identity, impairment, location, time, attire, activity, and availability of the individual receiving the passenger.

Another embodiment of the present invention can provide a real-time divorce management system including a processing arrangement having a processor and a non-transitory computer-readable medium having instructions stored thereon, the processing arrangement having a processor configured to execute the instructions, upon execution of the instructions, the processor is configured to perform the steps of analyzing a document uploaded to a database from a client device, extracting, from the uploaded document, predefined characteristics, generating, automatically, an output associated with the extract predefined characteristics, and storing an output associated with the extract predefined characteristics in a memory.

According to certain embodiments, the predefined characteristics may include one of characters, words, numbers, images, and symbols

According to certain embodiments, the processor may be further configured to identify, from the predefined characteristics, financial information, generate, from the financial information, financial responsibilities of at least one individual, and transmit, to the at least one individual, the financial responsibilities.

According to certain embodiments, the processor may be further configured to identify, from the predefined characteristics, at least one of dates and times and generate, a calendar populated with the at least one of dates and times.

According to certain embodiments, the processor may be further configured to identify, from the predefined characteristics, first financial information, identify, from a database, second financial information associated with a payment amount, compare the first financial information to the second financial information associated with the payment amount, and generate an estimated expected payment value based on the comparison.

According to certain embodiments, the processor may be further configured to identify, from the predefined characteristics, financial information, generate a document associated with the financial information, and populate the document with the identified financial information.

### BRIEF DESCRIPTION OF THE DRAWINGS

The features and advantages of the present invention can be more readily understood from the following detailed description with reference to the accompanying drawings, wherein:

FIG. 1 is a block diagram of an exemplary system according to embodiments of the present invention;

FIG. 2 is a block diagram of an exemplary system according to embodiments of the present invention; and

FIG. 3 is a block diagram of an exemplary real-time divorce management system according to embodiments of the present invention;

FIG. 4A is a block diagram of an exemplary real-time divorce management system according to embodiments of the present invention;

FIG. 4B is a block diagram of an exemplary real-time divorce management system according to embodiments of the present invention

FIG. 5 is a flow chart of an exemplary method according to embodiments of the present invention;

FIG. 6 is a flow chart of an exemplary method according to embodiments of the present invention;

FIG. 7 is a flow chart of an exemplary method according to embodiments of the present invention;

FIG. 8 is a block diagram of an exemplary real-time divorce management system according to embodiments of the present invention;

FIG. 9 is a flow chart of an exemplary method according to embodiments of the present invention;

FIG. 10 is a flow chart of an exemplary method according to embodiments of the present invention;

FIG. 11 is a block diagram of an exemplary real-time divorce management system according to embodiments of the present invention;

FIG. 12 is a flow chart of an exemplary method according to embodiments of the present invention;

FIG. 13 is a flow chart of an exemplary method according to embodiments of the present invention; and

FIG. 14 is a flow chart of an exemplary method according to embodiments of the present invention.

### DETAILED DESCRIPTION

Exemplary embodiments of the present invention are generally directed to a network-based real-time divorce support management system that can provide and facilitate assistance to clients desiring specialized services. For example, embodiments of the present invention can provide a mobile app-based platform to provide various services to individuals, such as divorcees, to assist them in navigating difficult situations and circumstances.

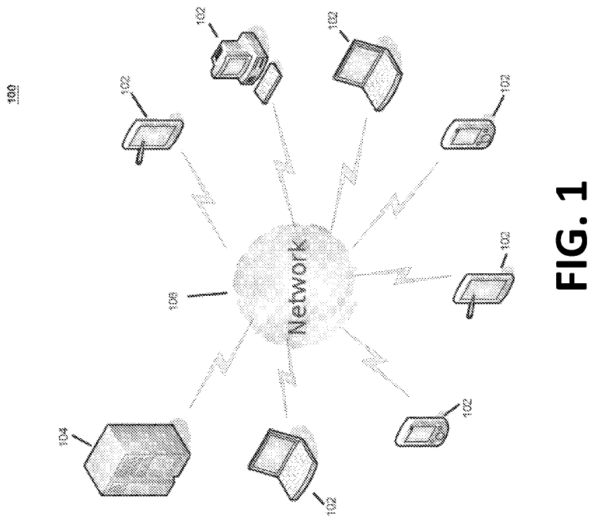

FIG. 1 shows an exemplary real-time divorce management system 100 according to an embodiment of the present invention. As shown in FIG. 1, exemplary system 100 can include one or more client devices 102 (e.g., smartphones, tablets, laptops, personal computers, etc.) communicating over a connected network 106 (e.g., wireless or wired) to one or more databases 104 (e.g., server, etc.) to enable real-time management of support for divorce. Each client device 102 can include a mobile device executing an application (e.g., an app or a web-based application) that can enable data transmission and communication over network 106 between client devices 102 and at least one database 104. According to certain aspects of the present invention, the exemplary systems and methods can provide, for example: generating and populating a Domestic Relations Financial Affidavit or other pre-settlement documents; facilitating communication between divorced individuals; automated payments and reimbursements between divorced co-parents of children; facilitating the arrangement of transportation for children of divorced co-parents; facilitating accounts payable and accounts receivable between divorced individuals; management of divorced individuals financials or co-mingled marital assets, expenses, and planning; and/or provide access to divorce related content.

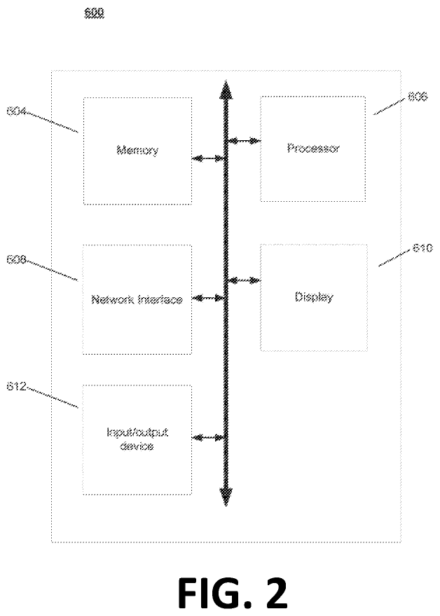

FIG. 2 shows a block diagram of an exemplary processing arrangement 600 according to embodiments of the present invention, on which exemplary embodiments of the present invention may be implemented. As shown in FIG. 1B, processing arrangement 600 can include memory 604, processor 606, network interface 608, display 610 and input/output device 612. Processing arrangement 600 may illustrate at least a portion of any systems, such as client device 102, a user may use in accordance with embodiments of exemplary real-time divorce management system 100. According to embodiments of the present invention, processing arrangement 600 can be configured and/or programmed to perform the exemplary methods described herein. For example, memory 604 can include a non-transitory computer-readable memory, which can have executable instructions stored thereon for a mobile or web-based application of exemplary real-time divorce management system 100, which can be executed by processor 606. Further, network interface 608 can, for example, facilitate transmitting and receiving data (e.g., wirelessly or wired) via a network to database 104. Further, GUIs and graphical representations can be displayed on display 610 and input/output device 612 can be used by a user to input various parameters and provide certain information.

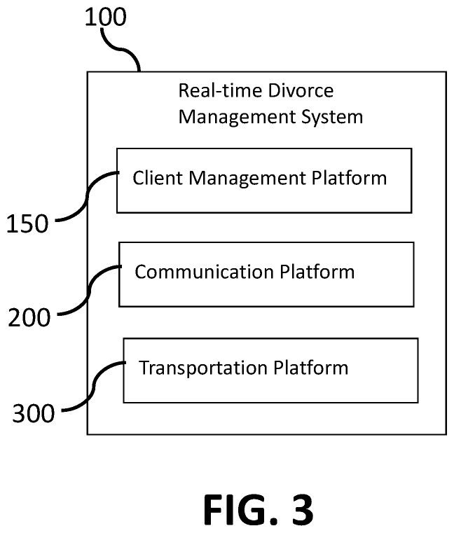

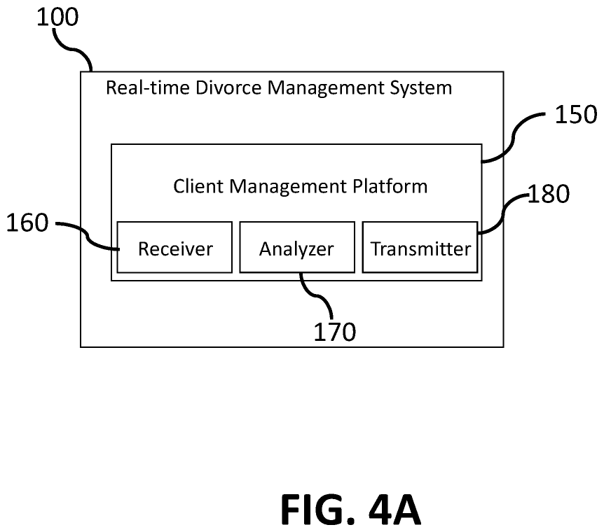

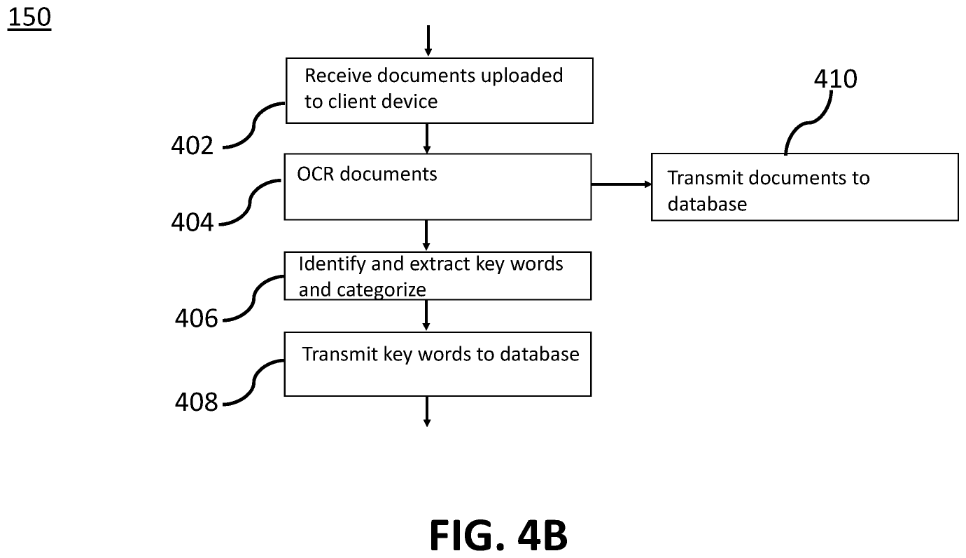

FIG. 3 shows a block diagram representation of exemplary real-time divorce management system 100 according to an embodiment of the presentation. As shown in FIG. 3, exemplary real-time divorce management system 100 can include one or more of client management platform 150, communication platform 200, and transportation platform 300. Each of the exemplary platforms can provide various functionality to exemplary real-time divorce management system 100 will be described in turn. As shown in FIG. 4A, client management platform (“CMP”) 150 may include receiver 160, analyzer 170, and transmitter 180. The various components of CMP 150 may be configured to intake and facilitate analyzing and processing of documents, such has a divorce documents, settlement agreements, financial documents, childcare documents, etc. CMP 150 may receive certain documents, analyze the documents to extract pertinent information and generated certain automated outputs and/or transmit the pertinent information to database 104, client device 102, or the necessary platform, such as communication platform 200 or transportation platform 300. For example, receiver 160 can receive document uploaded to CMP 150. Analyzer 170 may perform analysis on the uploaded document, such as text recognition to determine the content and characteristics of the document. Transmitter 180 may transmit the analyzed document to database 104 once analyzer 170 has performed the required analysis. As shown in FIG. 4B, step 402 shows CMP 150 may receive an image of documents to be processed (e.g., a user may capture an image of a document by scanning or taking a picture of an input document), such as a divorce settlement agreement. In certain instances, client device 102 may include an image sensor, such as a camera, that can perform the image capture of the document. The captured image of the divorce settlement agreement may be stored within memory 604 of client device 102. As shown in step 404, CMP 150 may analyze the image to extract information from the document by executing text recognition algorithms, such as optical character recognition (“OCR”), on the document. In step 410, once CMP 150 has performed OCR on the document, CMP 150 may transmit the document to database 104. As shown in step 406, once text recognition has been performed on the document, CMP 150 may identify and extract characteristics in the received document, and further may classify the analyzed document. Characteristics may include words, images, numbers, characters, or any other type of marking. CMP 150 may classify the uploaded document, for example, based on the extracted characteristics in the document. In one embodiment of the present invention, CMP 150 may compare each characteristic of the uploaded document to categorized characteristics in database 104 to determine which category each characteristic corresponds to. For example, CMP 150 may extract characteristics, such as words, relating to financial information, such as invoices, monetary values, purchases, receipts, bank account information, etc. These extracted characteristics relating to financial information may be categorized under a “Financials” category. CMP 150 may then generate spreadsheets, calendars, payment information, statements, invoices, etc. based on the financial information categorized under the “Financials” category. In one embodiment of the present invention, CMP 150 may redact the document based on the extracted characteristics. For example, if CMP 150 extracts characteristics relating to a social security number, a bank account number, etc., CMP 150 may redact the document prior to transmitting the document to database 104. The redaction of the document prevents third-parties, whom have access to database 104, from obtaining personal important information. Further, CMP 150 may extract characteristics relating to transportation, such as pick-up and drop-off times for sharing custody of a child, predetermined transportation vendors for transporting the child, status and identity of the individual picking up the child. The extracted characteristics relating to transportation may be categorized under a “Transportation” category by CMP 150. CMP 150 may transmit the extracted characteristics under the “Transportation” category to transportation platform 300 to facilitate the arrangement of transportation for a child or passenger. In another example, CMP 150 may extract a list of important events/task, important dates and milestones, task owners, deadlines, etc. This extracted list may be categorized under a “Tasks” category by CMP 150. CMP 150 may further generate a calendar populated with the various tasks under the “Tasks” category and transmit the calendar to device client 102. Further, as shown in step 408, CMP 150 may transmit the extracted characteristics to database 104 along with the associated categories. In one embodiment of the present invention, database 104 can be configured to include specific parameters in extracting and classifying information and generated the corresponding automated output. Alternatively, CMP 150 can employ machine learning to automatically instruct transportation platform 300 to arrange for transportation of a child when they consistently leave school at a specific time. For example, CMP 150 may record that a co-parent arranges transportation for a child every weekday at 3:00 PM, and CMP 150 may automatically begin to generate prompts for the co-parent to arrange transportation for the child at 3:00 PM. In further embodiments of the present invention, a live agent may be used to facilitate the categorization of characteristics in database 104. Alternatively, CMP 150 may receive instructions to categorize documents into specific categories.

In further embodiments of the present invention, client devices 102 and third-party applications may be provided access to database 104 by exemplary real-time divorce management system 100. For example, exemplary real-time divorce management system 100 may receive requests from client device 102 to transmit information, such as documents uploaded, communication logs, payment information, etc., to client device 102 of a mediator, therapist, judge, etc. Further, database 104 of exemplary real-time divorce management system 100 may communicate with third-party applications of client device 102 to allow exemplary real-time divorce management system 100 to, for example, monitor communications on client device 102 or input tasks onto a calendar of client device 102. In further embodiments, exemplary real-time divorce management system 100 may provide for application programming interfaces (APIs) to allow developers and programmers to build applications to interface and interact with exemplary real-time divorce management system 100.

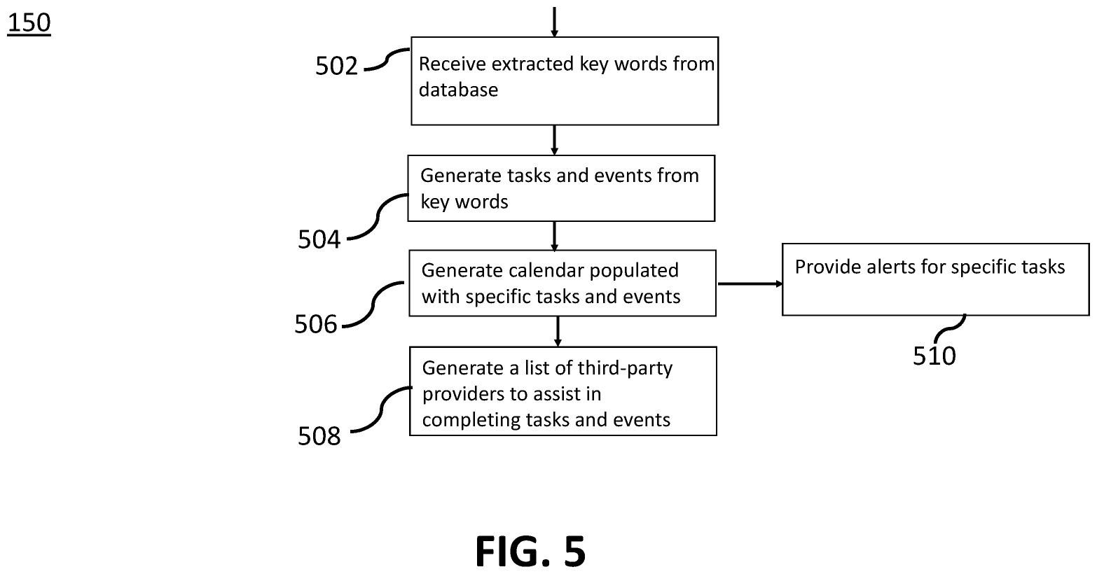

FIG. 5 shows an exemplary flow diagram of an exemplary method that can be performed by CMP 150. CMP 150 may facilitate organization and planning of events and tasks. As shown in step 502, CMP 150 may receive extracted characteristics from database 104. In step 504, CMP 150 may generate tasks and events from the extracted characteristics received from database 104. For example, CMP 150 may receive extracted characteristics from database 104 and may generate dates and times based on the extracted characteristics and generate events and tasks from the dates and times. In step 506, CMP 150 may generate a calendar populated with events and tasks based on the extracted characteristics from steps 502 and may further generate alerts and reminders as shown in step 510. For example, CMP 150 may generate, via the extracted characteristics, a task of planning a vacation by a certain date. CMP 150 may then generate a calendar on client device 102 populated with the task of planning a vacation on that certain date. In step 508, CMP 150 may generate a list of third-party providers to assist with completing the various tasks and events. For example, CMP 150 may generate a specific task of “finding employment” in step 503 based on the extracted characteristics, then in step 508, CMP 150 may generate a list of third-party employers based on various divorce support websites and other resources. In one embodiment, CMP 150 may utilize a live agent for complex documents. The live agent may manually determine events and tasks.

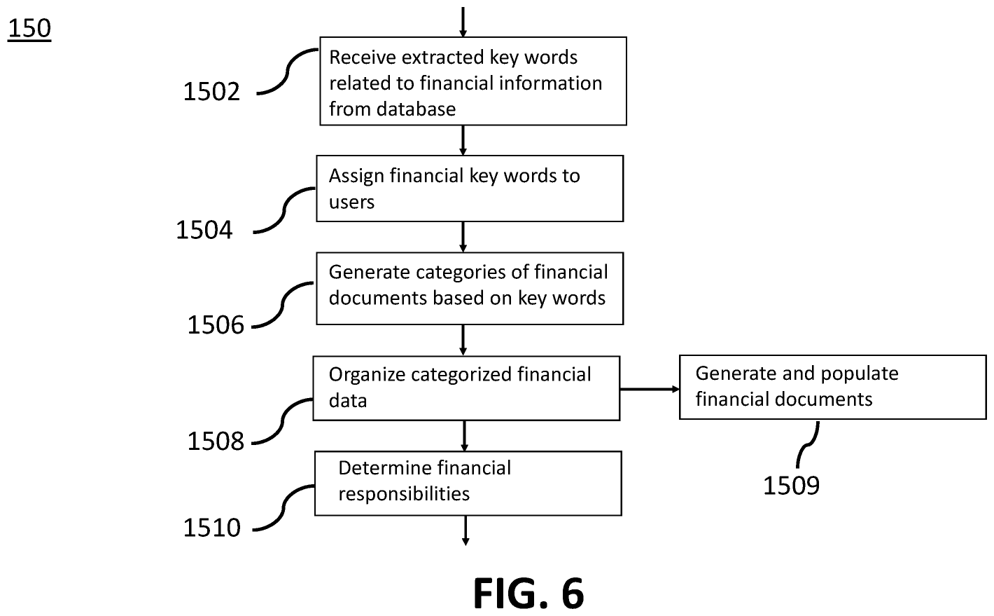

FIG. 6 shows one embodiment of an exemplary flow diagram of an exemplary method that can be performed by CMP 150 relating to financial documentation and information. Although FIG. 6 shows CMP 150 as it relates to financial information, CMP 150 may be used with any other type of information, such as divorce agreements, childcare information, deeds, etc. As shown in step 1502, CMP 150 may receive the extracted characteristics relating to financial information from database 104. In step 1504, CMP 150 may assign the extracted characteristics relating to financial information from database 104 to various users. CMP 150 may assign the extracted characteristics relating to financial information based on, for example, a divorce settlement agreement listing the financial responsibilities of the parties involved or based on manual input from a live agent, clients, or third-parties, such as mediators, counselors, judges, etc. In step 1506, CMP 150 may generate categories based on the financial characteristics, such as words and numbers. As shown in step 1508, CMP 150 may organize the financial documents based on the extracted characteristics into the created categories. For example, step 1506 may organize financial information into bills, mortgages, invoices, purchases, expenses, or any other category created by CMP 150. In step 1509, CMP 150 may generate and populate financial documents. For example, CMP 150 may generate a document, such as a Domestic Relations Financial Affidavit (“DRFA”), based on the organization of the financial data in step 1508, and populate the DRFA with the necessary information, such as income, debt, payments, assets, etc. of each user, based on the assigned financial key words in step 1504. A DRFA document can be used, for example, in support of claims for alimony/maintenance payments, child support, etc. In one embodiment of the present invention, CMP 150 may generate a DRFA based on information received from a private financial database. For example, CMP 150 may communicate with and receive information from a private financial institution and may extract financial data from the information to generate and populate a DRFA. In one embodiment of the present invention, CMP 150 may be used to determine estimates based on various factors before a divorce is initiated or consummated. For example, CMP 150 may receive financial information from client device 102 and may analyze the financial information to automatically extract and generate estimated values for things such as, e.g., expected child support payments, alimony, maintenance, legal fees, etc. associated with a divorce. CMP 150 may generate the expected payment amounts by analyzing and comparing the financial information from client device 102 to aggregated financial information associated with various other divorce settlement agreements and payment amounts stored on, for example, database 104, and other databases. As shown in step 1510, CMP 150 may allocate financial responsibilities to each individual that was assigned the extracted characteristics relating to financial information in step 1504. For example, a co-parent may be assigned financial words associated with child care, therefore all financial information associated with childcare may be assigned to that co-parent, and that co-parent would be financially responsible for all expenses related to childcare.

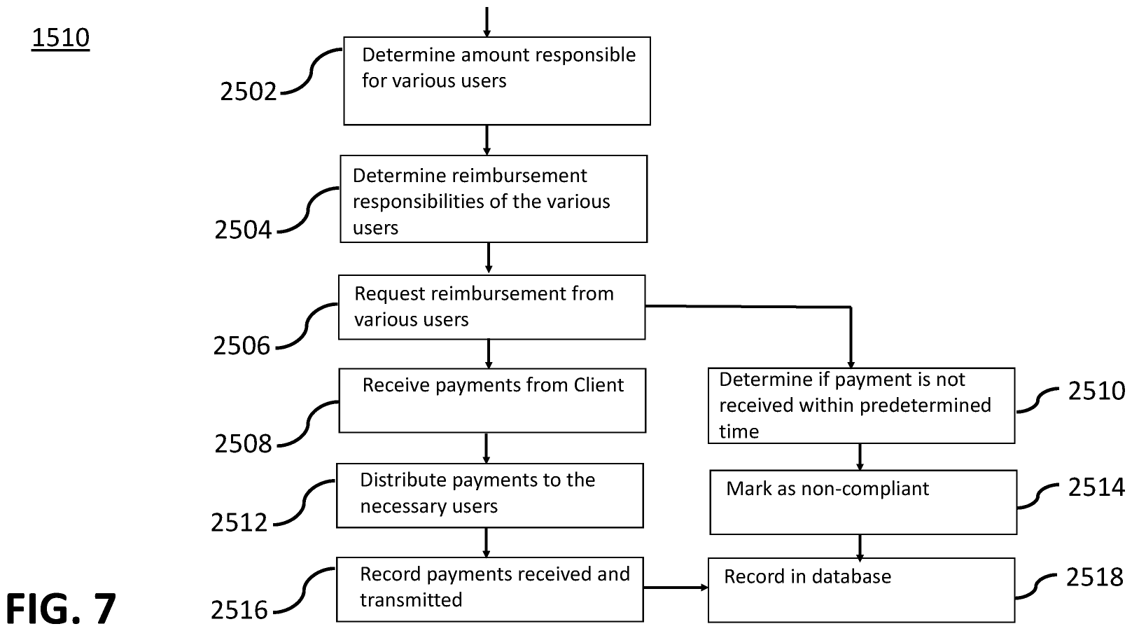

FIG. 7 further shows exemplary step 1510 that can be performed by CMP 150. As shown in step 2502, after CMP 150 assigns the extracted characteristics relating to financial information to various users, CMP 150 may calculate the amount each user is responsible for based on, for example, a divorce settlement agreement detailing the financial responsibilities of each party or based on an amount inputted by a user or a third party, such as a mediator or judge. Further, as shown in step 2504, CMP 150 may calculate how much each user has paid, and further may calculate reimbursement for each user associated with CMP 150. This may be determined based on which individual uploaded certain documents. For example, if a user uploaded invoices related to childcare, that user would then be associated with those invoices and CMP 150 would recognize that that user made those payments. Further, CMP 150 may receive input from client device 102 pertaining to payments associated with various users, such as co-parents of a child. For example, CMP 150 may receive a payment amount from a first co-parent pertaining to a certain amount they paid for childcare. Further, if the first co-parent has paid more money than required and the second co-parent has paid less money than required, CMP 150 in step 2504 may calculate that the second co-parent owes money to the first co-parent. In step 2506, CMP 150 may generate reimbursement requests for the necessary users owing money. In one embodiment of the present invention, CMP 150 may generate notifications to users via electronic communication requesting funds owed. For example, CMP 150 may generate an E-mail or a text requesting a payment submitted by another user. The E-mail or text may include a “Pay Now” option allowing the user to immediately pay the request amount. For example, CMP 150 may utilize and interface with a payment vendor (i.e., Venmo, PayPal, ACH, or other peer-to-peer payment systems, etc.) to receive and process payments. Further, as shown in step 508, CMP 150 may generate reminders for payments to remind various users of upcoming payments. As shown in step 2508, CMP 150 may receive the money requested in step 2506. In step 2512, once CMP 150 receives the money requested in step 2506, CMP 150 may distribute payments to the necessary clients. In one embodiment of the present invention, a user may input bank account information thereby providing CMP 150 access to their bank account for processing of payments. In one embodiment, CMP 150 may hold all payments received in a specific bank account associated with CMP 150 and distribute them to the necessary users, such as to the bank account of the co-parent. Further, in step 2516, CMP 150 may generate records of payments received and transmitted. For example, in step 2516, CMP 150 may record the payment as “Paid in Full.” CMP 150 may then generate a log of payments received and transmitted to the users. Further, CMP 150 may store the log of payments received and transmitted in database 104. In some instances, CMP 150 may not receive the money requested in 2506 or may receive an amount lower than requested, and in step 2510, CMP 150 may determine if it has not received the requested money in a predetermined amount of time, such as thirty days. If CMP 150 does not receive the requested money, then in step 2514, CMP 150 records the payment as “non-compliant.” In step 2518, CMP 150 may record the “non-compliant” marking in database 104. CMP 150 recording the “non-compliant” marking in database 104 allows a third-party, such as a mediator or judge, to access the payment records and determine whether or not a user, such as a co-parent, is making the required payments. Further, CMP 150 may generate accounts receivable statements from the payment records stored in database 104. In one embodiment of the present invention, CMP 150 may utilize a live agent to determine reimbursement requests, invoices, payments, statements, etc.

In addition to management of financial information of divorced individuals and co-parents, certain embodiments of the present invention can provide other functionality. For example, CMP 150 may communicate with various live agents specializing in divorce specific areas. In one embodiment of the present invention, CMP 150 may receive a request from a user to transmit information pertaining to a financial advisor to aid in refinancing of a marital residence or division of financial assets.

In another embodiment, CMP 150 may receive requests from a user's accounts associated with client device 102, thereby providing communication between CMP 150 and the user's account, allowing the user to manage various account activities through CMP 150. Further, CMP 150 may receive requests from specific applications to project manage post-settlement activities such as division of financial assets, refinancing of marital residence, updating account holder information for utilities, transferring of vehicle ownership, acquiring healthcare, updating beneficiary information, etc. CMP 150 may communicate with a live agent to assist in managing post-settlement activities. Further, CMP 150 may generate a list of and communicate with various divorce support groups, childcare services, shelters, service hotlines, law firms, therapists, recruiters, wellness and healthcare facilities, divorce-related educational materials, divorce support media, etc. In one embodiment of the present invention, CMP 150 may generate a list of various divorce related services based on location. For example, CMP 150 may receive location information from memory 604 of client device 102 and generate a list of divorce related services nearby.

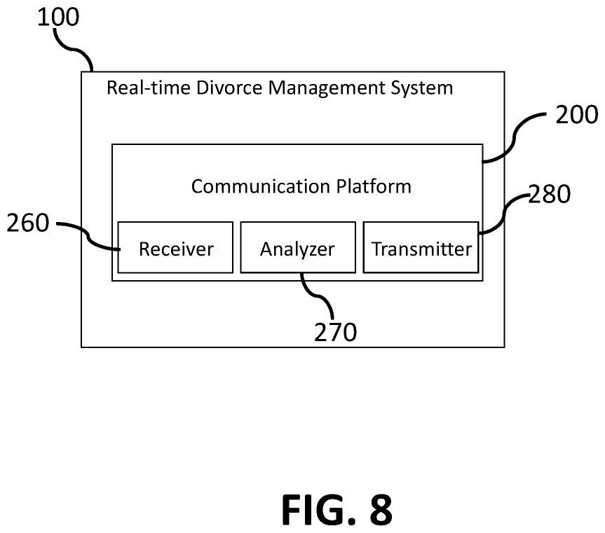

FIG. 8 shows exemplary real-time divorce management system 100 which may include communication platform 200. Communication platform 200 may include receiver 260, analyzer 270, and transmitter 280. Receiver 260 can receive communications from memory 606 of client device 102. Analyzer 270 may monitor communications and perform analysis on the monitored communications, such as filtering of predefined characteristics from the monitored communications. Transmitter 180 may transmit the filtered communication generated by analyzer 270. Communication platform 200 may facilitate communication between various users or divorcees. For example, a user may have an abusive former partner who may be sending abusive texts or harassing the user. Communication platform 200 of exemplary real-time divorce management system 100 may monitor text messages, voice mails, e-mails, or any other type of communication.

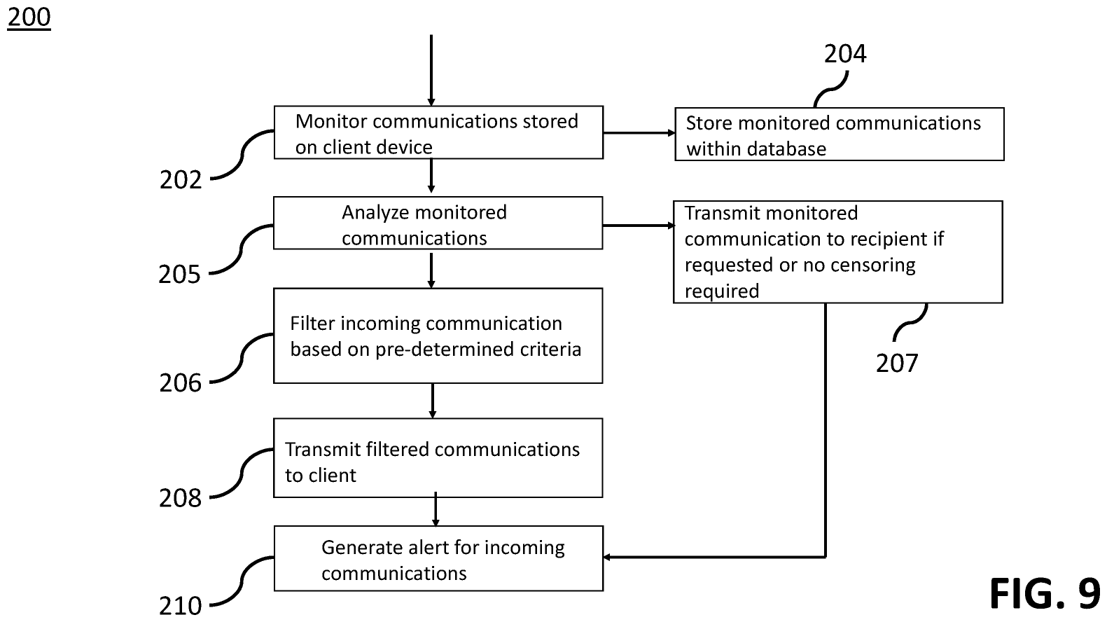

As shown in FIG. 9, in step 202, communication platform 200 may monitor communications. Communication platform 200 may monitor communications directed at, for example, a divorced individual from an abusive former partner. For example, various communication applications (i.e., iMessages, Android Messenger, FaceBook Messenger, WhatsApp, Blackberry Messenger, Snapchat, Twitter, E-Mail, voicemail, etc.) may be stored on memory 604 of client device 102 and communication platform 200 may be running in the background of client device 102. Further, communication platform 200 may monitor incoming audio transmissions, such as phone calls, Voice over IP (Vol P), Wi-Fi calls, etc. Communication platform 200 may monitor incoming communications received by client device 102 in substantially real-time. Communication platform 200 may monitor voice messages, calls, text messages, electronic mail, images, Snap Chats, social media posts, or any other type of communication. As shown in step 204, communication platform 200 may store the monitored communications within database 104. Communication platform 200 may store the monitored communications within database 104 for a predetermined period of time, such as 30 days. After the predetermined period of time, the message may be deleted or sent to a remote back-up server. In step 205, communication platform 200 may analyze the monitored communications. Analysis of the communications may include voice recognition, speech processing, optical character recognition, machine learning, and/or live agents screening communication for predefined characteristics, such as harmful and disturbing images, abusive language, non-fact-based communications which could cause emotional distress to the recipient, etc. In step 206, communication platform 200 may review the monitored communication and may generate filtered communications based on predetermined criteria. Communication platform 200 generating filtered communications may include replacing text with other text, such as “Filtered” or “Redacted” or images, such as symbols, replacing images with “Image Removed,” or blurring out the image. In one embodiment of the present invention, communication platform 200 may perform image analysis on the monitored communications to determine if the monitored communications contain the predefined characteristics, such as disturbing or crude images. In further embodiments of the present invention, communication platform 200 may utilize voice recognition to analyze phone calls. For example, communication platform 200 may recognize predefined characteristics, such as words, in a phone call and may delay the audio transmission to client device 102 to allow communication platform 200 to filter the audio for the predefined characteristics. Further, communication platform 200 may choose not to forward the monitored communication to the recipient if, for example, the monitored communication contains only characteristics that meet the predetermined criteria. The predetermined criteria may include profanity, abusive language, sexual harassment, crude and obscene language/images, nudity, pornographic images, disturbing images or content etc. In one embodiment, database 104 may include a list of abusive characteristics and material under an “Filtered Characteristics” category. Communication platform 200 may compare the characteristics, such as images and words, in the monitored communication with the predefined characteristics in the “Filtered Characteristics” category and may filter the corresponding characteristics from the monitored communications. In step 208, once communication platform 200 generates the necessary filtered communications and receives approval of the filtering, communication platform 200 may transmit the generated filtered communications to the recipient. In one embodiment, the transmission of the filtered communication occurs within a predetermined time period after monitoring of the communication, such as 2 minutes. In step 210, once communication platform 200 transmits the generated filtered communication, communication platform 200 may generate and transmit an alert to the recipient notifying them about the incoming filtered communication. As shown in step 207, communication platform 200 may transmit the original message, after being analyzed, to the recipient if the recipient chooses to receive the original, unfiltered monitored communication, or if no filtering is required. In one embodiment of the present invention, communication platform 200 may generate filtered communication which may be further screened and filtered by a live agent if necessary. For example, if communication platform 200 is unable to read and decipher the monitored communications, communication platform 200 may transmit the monitored communication to a live agent for filtering.

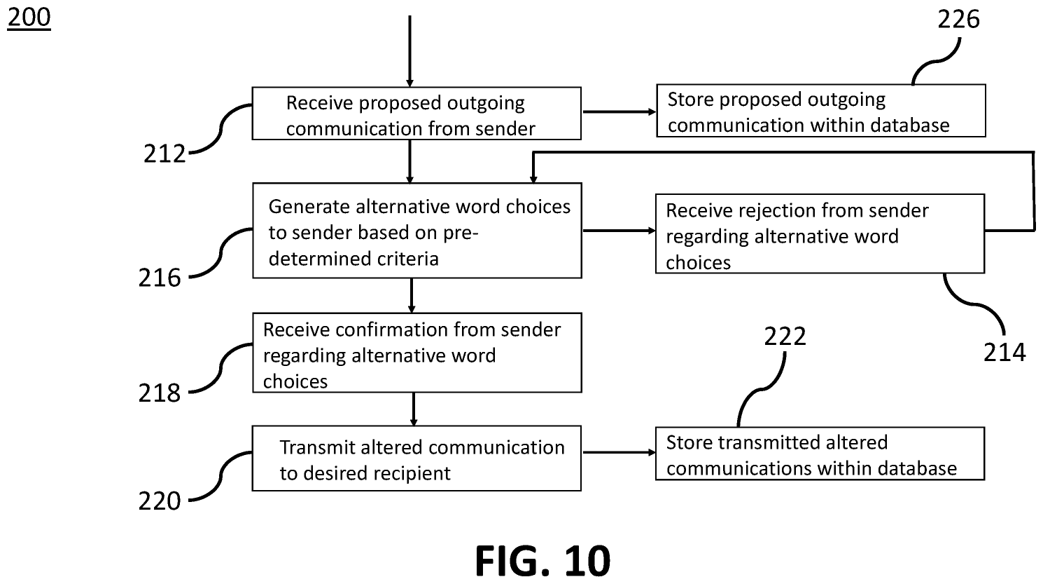

Further, as shown in FIG. 10, communication platform 200 of exemplary divorce support management system 100 may also provide for screening and filtering of outgoing communications. In step 212, communication platform 200 may receive a proposed outgoing communication from client device 102. As shown in step 226, communication platform 200 may store the proposed outgoing communication within database 104. In step 216, communication platform 200 may review the proposed outgoing communication received in step 212 and may generate alternative characteristics choices, such as words or image, based on predetermined criteria. In one embodiment of the present invention, communication platform 200 may generate and transmit a notification to the sender of the outgoing communication that the communication includes characteristics that meet predetermined criteria. The predetermined criteria may include profanity, abusive language, sexual harassment, crude and obscene language/images, disturbing content, nudity, pornographic images, etc. The outgoing communication may be reviewed by communication platform 200 or by a live agent for characteristics which, for example, could cause emotional distress to the recipient. In step 214, the sender may reject the alternative characteristics from step 216. If communication platform 200 receives a rejection in step 214, communication platform 200 may generate and transmit another alternative characteristic. However, to prevent a potential endless loop, communication platform 200 may limit the number rejections the client is able to make. For example, after generating and transmitting three alternative characteristics, and receiving three rejections in step 214, communication platform 200 may prevent any outgoing message for a predetermined amount of time, such as 15 minutes. In step 218, communication platform 200 may receive a confirmation from the sender regarding approval of alternative characteristics, such as alternative word choices, in step 216. In step 220, after receiving the confirmation from the sender regarding the alternative characteristics, communication platform 200 may generate and transmit the altered communication to the desired recipient. In step 222, the generated and transmitted altered communication may be stored within database 104.

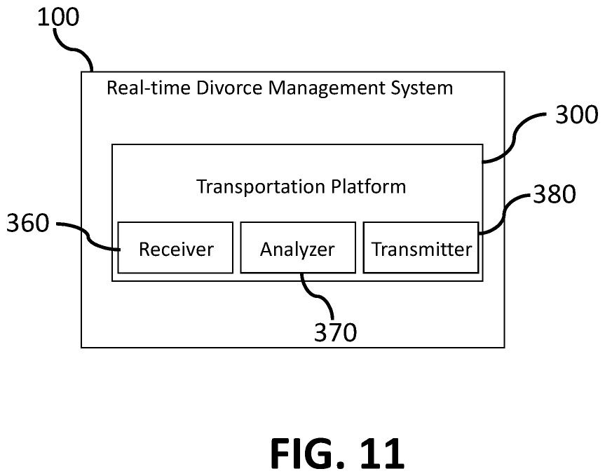

FIG. 11 shows exemplary real-time divorce management system 100 which may include transportation platform 300. Transportation platform 300 may include receiver 360, analyzer 370, and transmitter 380. Receiver 360 can receive extracted transportation related characteristics, such as words related to transportation, from database 104. Analyzer 370 may arrange for reservation of a child or passenger and may further check and record the arrival information of the child or passenger. Transmitter 380 may transmit arrival information to client device 102 and/or database 104. Transportation platform 300 may be used to facilitate the transportation of children of divorced co-parents. Transportation platform 300 can allow for the reservation of predetermined authorized transportation vendors to transport children from various locations. For example, transportation platform 300 may transmit information to the predetermined authorized transportation vendors regarding various custody arrangements finalized in a divorce decree.

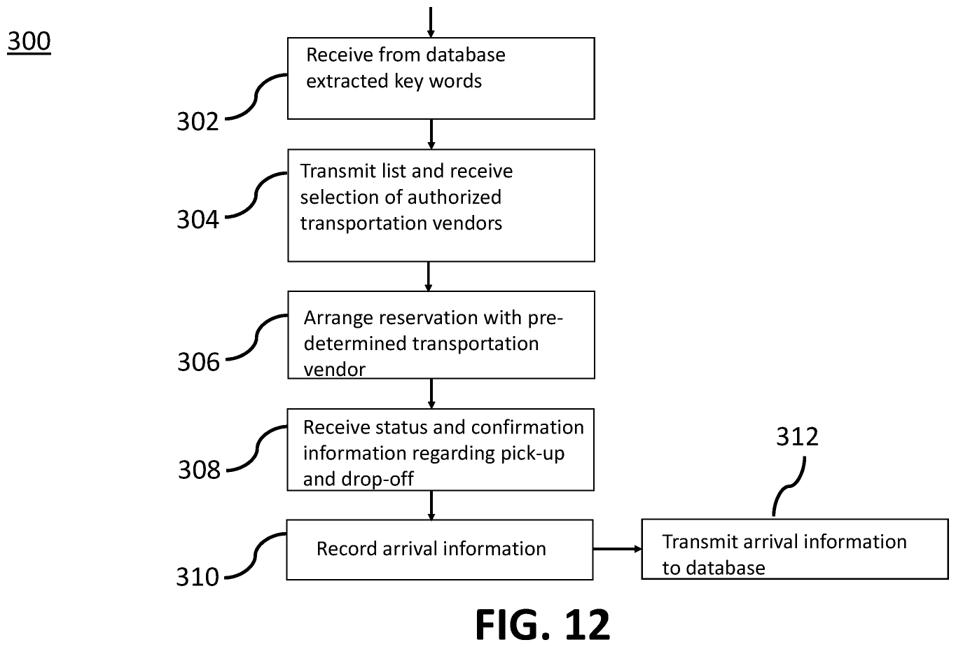

FIG. 12 shows an exemplary flow diagram of an exemplary method that can be performed by transportation platform 300 of exemplary real-time divorce management system 100. Transportation platform 300 may be used to arrange transportation of children of divorced co-parents. For example, a first co-parent may use transportation platform 300 to safely arrange transportation of a child with a second co-parent through a third-party transportation vendor. As shown in FIG. 12, in step 302, transportation platform 300 may receive, from database 104, extracted characteristics, such as words, directed towards transportation or under a “Transportation” category, such as authorized third-party transportation vendors, pick-up/drop-off locations and times, authorized pick-up individuals, etc. For example, transportation platform 300 may receive from step 302 a list of authorized transportation vendors such as taxi or car services, Uber, Lyft, Gett, Via, or any other transportation vendor. In another example, transportation example 300 may receive from step 302 predetermined pick-up and drop-off times and locations. As shown in step 304, transportation platform 300 may transmit the list of authorized transportation vendors to client device 102 and may then receive a selection of an authorized transportation vendor from the list of authorized transportation vendors from client device 102. Transportation platform 300 may then generate a reservation with the selected authorized transportation vendor. As shown in step 308, once the reservation is approved by the selected authorized transportation vendor, transportation platform 300 may receive status and confirmation information regarding pick-up and drop-off times, and the pick-up and drop-off locations of the child being transported, and status and identity of individual picking up the child. In step 310, transportation platform 300 may generate arrival information of the child and in step 312, transmit the arrival information to database 104. Arrival information may include arrival time and location, status of the individual picking-up the child, and further may include a rating given by the transportation vendor based on the passenger, such as cleanliness, timeliness, behavior, etc. Optionally, transportation platform 300 may receive categorized transportation vendor ratings from third-party applications, such as Uber, Lyft, Gett, Via, Juno, etc. Transportation platform 300 may receive the ratings from the selected authorized transportation vendor of a driver in connection with specific criteria. For example, transportation platform 300 may receive ratings of a driver from a specific category of raters, such as, for example parents, caretakers, guardians, children, etc. Alternatively, the received ratings may include a specific rating category directed to the driver's performance in providing child pick-up and drop-off services. Transportation platform 300 may transmit this specific category of ratings of the transportation vendor to client device 102. In another embodiment of the present invention, Transportation platform 300 may receive a rating from client device 102 of the selected authorized transportation vendor and may transmit the rating associated with the selected authorized transportation vendor to database 104.

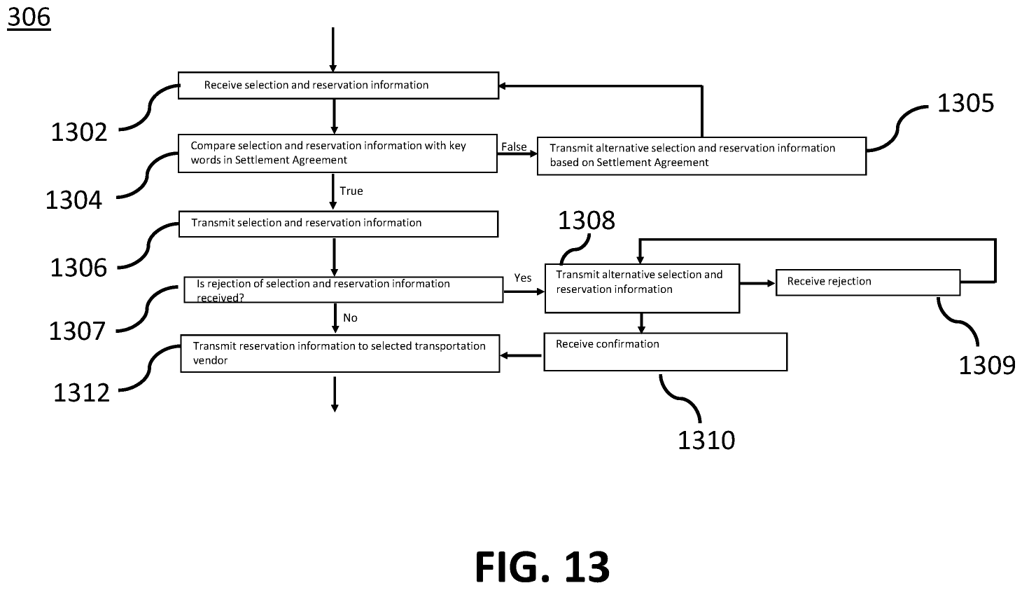

FIG. 13 shows an exemplary flow diagram of exemplary step 306 that can be performed by transportation platform 300 of exemplary real-time divorce management system 100. As shown in step 1302, transportation platform 300 may receive selection and reservation information. For example, transportation platform 300 may receive selection of an authorized transportation vendor and pick-up time and location for the individual being transported. In step 1304, the selection and reservation information may be compared with extracted transportation characteristics, such as words related to transportation, in database 104 to ensure that the selection and reservation information is in compliance. As shown in step 1305, if the selection and reservation information is not in compliance with the divorce settlement agreement, transportation platform may generate and transmit alternative selection and reservation information. Transportation platform 300 then may receive the alternative selection and reservation information, and in step 1304, again compare the alternative selection and reservation with the terms in divorce settlement agreement. As shown in step 1306, once the selection and reservation information are confirmed to be in compliance with the extracted characteristics from database 104, transportation platform 300 may generate and transmit the selection and reservation information to the individual picking up the child. As shown in step 1307, transportation platform 300 may determine if transportation platform 300 receives a rejection of the selection and reservation information transmitted in step 1306. In step 1308, if transportation platform 300 receives a rejection, transportation platform 300 may generate and transmit alternative selection and reservation information based on extracted characteristics in database 104. In step 1309, if transportation platform 300 receives a rejection of the alternative selection and reservation information, transportation platform 300 may generate and transmit another alternative selection and reservation information based on the extracted characteristics in database 104. However, to prevent a potential endless loop, transportation platform 300 may limit the number rejections received. For example, after generating and transmitting three alternative selection and reservation information options, and after receiving three rejections in step 1309, transportation platform 300 may cancel the selection and reservation information, thereby cancelling the arrangement of transportation. In one embodiment of the present invention, transportation platform 300 may generate and transmit to database 104 a log of the multiple rejections. However, in step 1310, transportation platform 300 may receive confirmation regarding the alternative selection and reservation information. As shown in step 1312, if transportation platform 300 does not receive a rejection of the selection and reservation information, then transportation platform 300 may transmit the reservation information to the selected transportation vendor and proceed to step 308.

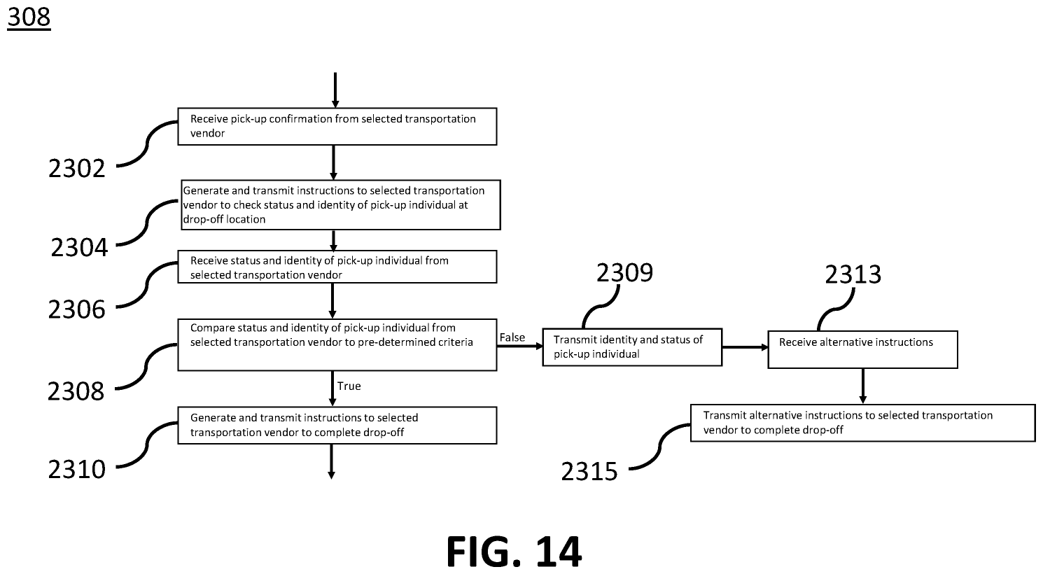

FIG. 14 shows an exemplary flow diagram of exemplary step 308 that can be performed by transportation platform 300 of exemplary real-time divorce management system 100. As shown in step 2302, transportation platform 300 may receive pick-up confirmation of the passenger, such as a child, from the selected authorized transportation vendor selected in step 304 in FIG. 12. In step 2304, transportation platform 300 may generate and transmit instructions to the selected authorized transportation vendor to check the status and identity of the individual picking up the child. For example, transportation platform 300 may generate and transmit instructions to the selected authorized transportation vendor to check the identity of the individual picking up the child, such as a driver's license, passport, or other government issued identification, and further may generate and transmit instructions to the selected authorized transportation vendor to check the status of the individual picking up the child, such as intoxication, impairment, or other safety concerns. As shown in step 2306, transportation platform 300 may receive the status and identity of the individual picking up the child from the selected authorized transportation vendor. In step 2308, transportation platform 300 may compare the status and identity of the individual picking up the child to predetermined criteria. The predetermined criteria may be based on extracted characteristics, such as words related to transportation, received from database 104, such as identities of individuals authorized to pick-up the child, authorized drop-off locations, authorized drop-off times, etc. In one embodiment of the present invention, transportation platform 300 may generate and transmit to the selected authorized transportation vendor in step 2304 a survey, such as a multiple-choice survey, to assess the status of the individual picking up the child. The response to the survey may be compared with the predetermined criteria in database 104 or may be sent to a live agent to assess the safety of the individual picking up the child. As shown in step 2309, if the compared status and identity does not match the predetermined criteria, then transportation platform 300 may transmit the identity and status of the pick-up individual. For example, transportation platform 300 may generate and transmit an alert to the individual initiating the transportation of the child notifying them of the identity and status of the pick-up individual. In step 2313, transportation platform 300 may receive alternative instructions from the individual initiating the transportation. For example, if the status or identity does not match the predetermined criteria when compared in step 2308, transportation platform 300 may receive alternative instructions from the individual initiating the transportation to drop-off the child or passenger at another location or return the child or passenger to the pick-up location. Then in step 2315, transportation platform 300 may transmit the alternative instructions to the selected authorized transportation vendor to complete the alternative instructions. Further, if in step 2308 the compared status and identity of the pick-up individual complies with the predetermined criteria, transportation platform 300 may generate and transmit instructions to the selected authorized transportation vendor to drop-off the child or passenger. In one embodiment of the present invention, if in step 2308 the compared status and identity of the pick-up individual complies with the predetermined criteria, transportation platform 300 may still transmit the status and identity of the pick-up individual, and then may generate and transmit instructions to the selected authorized transportation vendor to complete the drop-off the child or passenger.

In one embodiment of the present invention, exemplary real-time divorce management system 100 may utilize cloud computing. For example, database 104 of exemplary real-time divorce management system 100 may store large amounts of information on various servers and devices via network 106. Further, database 104 of exemplary real-time divorce management system 100 may receive large amounts of information from third-party private sources, such as Google, FaceBook, LinkedIn, YouTube, banks and other financial institutions, etc. For example, database 104 may receive large amounts of information or data from a bank relating to account statements and monthly invoices. Further, database 104 of exemplary real-time divorce management system 100 may receive large amount of information or data from third-party public sources, such as databases maintained by the public sector, state government databases, sex-offender registries, departments of motor vehicles, departments for tax, court systems, etc. For example, database 104 may receive large amounts of information or data relating to digital records and filings maintained by the state government relating to family law cases. Database 104 may also receive large amounts of information or data relating to the settlement agreements received by CMP 150. The large amounts of information or data may be transmitted from database 104 via network 106 to be stored on servers, or other devices, such as computers, phones, tablets, etc. Database 104 of exemplary real-time divorce management system 100 utilizing cloud computing may allow for analysis and comparison of various divorces related information. For example, database 104 may store information of each client device 102 of exemplary real-time divorce management system 100, which may be transmitted via network 106 to servers. Exemplary real-time divorce management system 100 may access database 104 or these servers to compare, for example, divorce settlement agreements of various client devices 102. For example, exemplary real-time divorce management system 100 may compare various divorce settlement agreements to compare settlement outcomes to family incomes and number of dependents, and may transmit this comparison information to database 104, servers, or third-party applications. The comparison information may be used to assist lawyers and per se clients in substantiating a case for child support and/or alimony. Further, the comparison information may assist with lobbying for state-wide policy changes. In another example, exemplary real-time divorce management system 100 can assist users before a divorce settlement is reached, such as by analyzing and comparing the user's family's criteria (e.g. combined adjusted gross income, number of dependents, etc.) with settlement outcomes of other families of similar type. Exemplary real-time divorce management system 100 may receive information from archives of both in-state and out-of-state Settlement Agreements of various other families to allow for comparison and analysis. Information obtained from any such databases can be used, for example, to determine expected payment amounts for an individual with similar financial information. For example, CMP 150 may receive financial information from client device 102 and compare the received financial information to financial information associated with divorce settlement agreements stored in database 104, servers, or third-party applications. CMP 150 may then extract payment amounts from the divorce settlement agreements and generate expected payment amounts based on the comparison.

Exemplary real-time divorce management system 100 may further utilize machine learning to automatically perform certain tasks based on the statistical probability of the task occurring. For example, CMP 150 of exemplary real-time divorce management system 100 may consistently receive uploaded invoices for childcare services at the end of every month. CMP 150 of exemplary real-time divorce management system 100 may utilize machine learning, for example, to transmit a prompt to client device 102 before the end of every month to upload an invoice for childcare services and may automatically generate and transmit reimbursement and payment requests upon uploading of the invoice for childcare services.

The embodiments and examples shown above are illustrative, and many variations can be introduced to them without departing from the spirit of the disclosure. For example, elements and/or features of different illustrative and exemplary embodiments herein may be combined with each other and/or substituted with each other within the scope of the disclosure. For a better understanding of the disclosure, reference should be had to any accompanying drawings and descriptive matter in which there is illustrated exemplary embodiments of the present invention.

What is claimed is:

1. A real-time divorce management system comprising a processing arrangement including a processor and a non-transitory computer-readable medium having instructions stored thereon, the processing arrangement including a processor configured to execute the instructions, upon execution of the instructions, the processor is configured to perform the steps of:
obtaining an incoming electronic communication;
storing the incoming electronic communication on a memory;
identifying, by the processor, at least one predefined characteristic contained in the incoming electronic communication;
filtering, by the processor, the at least one predefined characteristic contained in the incoming electronic communication to generate at least one filtered electronic communication, wherein the at least one filtered electronic communication is a modified version of the incoming electronic communication with the at least one predefined characteristic having been filtered;
generate an alert on a client device notifying a user associated with the client device of the at least one filtered electronic communication; and
providing, via the client device and based on a response to the alert, the incoming electronic communication and the at least one filtered electronic communication to the user.

2. The real-time divorce management system of claim 1, wherein the modified version of the incoming electronic communication includes modification to the predefined characteristics of the incoming electronic communication.

3. The real-time divorce management system of claim 1, wherein the incoming electronic communication includes one of a text message, a picture message, an electronic mail, phone calls, VoIP, Wi-Fi calls, or a voicemail.

4. The real-time divorce management system of claim 1, wherein predefined characteristics includes words or images that include at least one of profanity, nudity, violent content, disturbing content, threatening content, graphically violent or sexual content, or emotionally disturbing content.

5. A computer-implemented method, comprising:
obtaining an incoming electronic communication;
processing the incoming electronic communication to identify, based at least in part on a plurality of predetermined criteria, at least one portion of the incoming electronic communication;
generating a filtered electronic communication from the incoming electronic communication, wherein the at least one portion of the incoming electronic communication has been removed from the filtered electronic communication and the filtered electronic communication includes an indication that the at least one portion was removed;
causing, at a client device, a notification to be generated notifying a recipient of the filtered electronic communication; and
subsequent to causing the notification to be generated, causing, based at least in part on an interaction with the notification, the incoming electronic communication and the filtered electronic communication to be provided to the recipient.

6. The computer-implemented method of claim 5, wherein the incoming electronic communication includes at least one of:
a telephone call;
an instant message;
an image; or
a social media post.

7. The computer-implemented method of claim 5, further comprising:
storing the incoming electronic communication for a predetermined period of time; and
deleting, after the predetermined period of time has passed, the incoming electronic communication.

8. The computer-implemented method of claim 5, further comprising:
receiving, from the sender, a second indication indicating a rejection of the filtered electronic communication; and
in response to receipt of the second indication, generating a second filtered electronic communication.

9. The computer-implemented method of claim 5, further comprising:
obtaining an outgoing communication;
processing the outgoing communication to identify, based at least in part on the plurality of predetermined criteria, at least one second portion of the outgoing communication;
generating a second filtered communication from the outgoing communication, wherein the at least one second portion of the outgoing communication has been removed from the second filtered communication and the second filtered communication includes a second indication that the at least one second portion was removed;
causing, at a second client device, a second notification to be generated notifying a sender of the second filtered communication; and
obtaining a second interaction with the second notification;
generating, based at least in part on the second interaction with the second notification, a third filtered communication; and
causing, at the second client device, a third notification to be generated, notifying the sender of the third filtered communication; and
causing, based at least in part on a third interaction with the third notification, the third filtered communication to be provided to the recipient.
